(19) United States
(12) Patent Application Publication
(10) Pub. No.: US 2018/0070109 A1
(43) Pub. Date: Mar. 8, 2018

(54) ENCODING OF IMAGES BY VECTOR QUANTIZATION

(71) Applicant: Orange, Paris (FR)

(72) Inventors: Felix Henry, Saint Gregoire (FR); Bihong Huang, Cesson Sevigne (FR)

(21) Appl. No.: 15/551,804

(22) PCT Filed: Feb. 18, 2016
(86) PCT No.: PCT/FR2016/050373

§ 371 Date: Aug. 17, 2017

(30) Foreign Application Priority Data
Feb. 19, 2015 (FR) 1551420

(51) Int. Cl. H04N 19/94; H04N 19/137; H04N 19/176; H04N 19/124; H04N 19/105

(52) U.S. Cl. CPC H04N 19/94; H04N 19/137; H04N 19/593; H04N 19/124; H04N 19/105; H04N 19/176

(57) ABSTRACT

A method is provided for encoding of at least one image. The encoding method implements, for a current block to be coded for the image: predicting current block according to a prediction procedure selected from among a plurality of predetermined prediction procedures; obtaining a predictor block from the prediction; calculating a first set of data representing a comparison between the predictor block obtained and the current block; comparing the calculated first set with a plurality of quantization vectors; selecting one of the vectors according to a predetermined encoding performance criterion; encoding an index associated with the selected vector; calculating a second set of data representing a comparison between the first calculated data set and the selected vector; and encoding the second calculated data set. During the encoding, at least one of the quantization vectors is modified on the basis of the data from the second calculated data set.

### FIELD OF THE INVENTION

The present invention pertains generally to the field of image processing and more precisely to the coding and to the decoding of digital images and of sequences of digital images.

The invention can be applied in particular, but not exclusively, to the video coding implemented in current AVC and HEVC video coders and their extensions (MVC, 3D-AVC, MV-HEVC, 3D-HEVC, etc), as well as to the corresponding decoding.

### BACKGROUND OF THE INVENTION

Current video coders (MPEG, H.264, HEVC, etc) use a block-wise representation of the images to be coded. The images are subdivided into blocks of square or rectangular shape, which are liable to be subdivided in their turn in a recursive manner.

For at least one block considered from among the various blocks obtained, a prediction of pixels of the block considered is implemented with respect to prediction pixels which belong either to the same image (Intra prediction), or to one or more previous images of a sequence of images (Inter prediction) which have already been decoded. Such previous images are conventionally called reference images and are preserved in memory either at the coder or at the decoder. In the course of such a prediction, a set of data is calculated by subtracting the pixels of the block considered, from the prediction pixels. The coefficients of the calculated data set are then quantized after a possible mathematical transformation, for example of discrete cosine transform type (DCT), and then coded by an entropy coder. The coded data are written into a data signal intended to be transmitted to a decoder.

Said data signal comprises in particular:
the type of prediction (Intra prediction, Inter prediction, default prediction carrying out a prediction for which no information is transmitted to the decoder (in English “skip”));
the mode of prediction (direction of prediction, reference image component, etc);
the type of subdivision into sub-blocks;
the type of transform, for example 4×4 DCT, 8×8 DCT, etc . . . ;
the values of pixels, the values of transformed coefficients, amplitudes, signs of quantized coefficients of the pixels contained in the block or the sub-block considered.

Once the data signal has been received by the decoder, the decoding is done image by image, and for each image, block by block. For each block, the corresponding elements of the data signal are read. The inverse quantization and the inverse transformation of the coefficients of the blocks are performed so as to produce a decoded block of residual data. Next, the prediction of the block is calculated and the block is reconstructed by adding the prediction to the decoded block of residual data.

In a manner known per se, the quantization of the coefficients of the calculated block of residual data can be of scalar or vector type.

The scalar quantization uses a quantization step which is determined on coding on the basis of a parameter called QP (English abbreviation standing for “Quantization Parameter”).

The vector quantization consists on coding:
in comparing the calculated set of residual data with a plurality of quantization vectors grouped together in at least one dictionary,
in selecting one of the quantization vectors according to a predetermined coding performance criterion, such as for example the bitrate-distortion compromise well known to the person skilled in the art,
in coding an index associated with said selected quantization vector.

The coded index is then transmitted in the data signal destined for the decoder which contains the same dictionary or dictionaries as the coder and which applies the inverse vector quantization by decoding said transmitted index, and then by determining the quantization vector associated with said decoded index.

Having regard to the fact that the quantization vectors form part of a predetermined dictionary, the coding of the current block by vector quantization may turn out to be poorly suited to the statistics of the video signal.

Ultimately, this results in unsatisfactory compression performance.

### Object and Summary of the Invention

One of the aims of the invention is to remedy drawbacks of the aforementioned prior art.

For this purpose, a subject of the present invention relates to a method for coding at least one image split into blocks, implementing, for a current block to be coded of the image:
a prediction of the current block in accordance with a mode of prediction selected from among a plurality of predetermined modes of prediction,
an obtaining of a predictor block on completion of the prediction,
a calculation of a first set of data representative of a difference between the predictor block obtained and the current block,
a comparison of the first calculated set of data with a plurality of quantization vectors,
a selection of one of the quantization vectors according to a predetermined coding performance criterion,
a coding of an index associated with the selected quantization vector.

The coding method according to the invention is noteworthy in that it comprises:
a calculation of a second set of data representative of a difference between the first calculated set of data and the selected quantization vector,
a coding of the second calculated set of data in the course of which at least one of the quantization vectors is modified as a function of the data of the second calculated set of data.

Such a provision advantageously makes it possible to aggregate:
the benefit derived from utilizing the correlations between the first current set of residual data and the quantization vectors of a dictionary,
and the benefit derived from an updating of at least one of said quantization vectors, said updating making it possible to adapt, in the course of time, to the modifications of the signal of coded data.

The prediction of the current block is thus both more precise and more suited to the current video context, the advantage of this being to significantly improve the performance in respect of compression of the signal of coded data to be transmitted to the decoder.

In a particular embodiment, the modification of one of the quantization vectors is implemented only if the data of the second calculated set of data fulfill a predetermined criterion.

Such a provision makes it possible for the modification of one of the quantization vectors to be performed only when this modification is substantial, thereby avoiding needless calculations.

In another particular embodiment, the modification of one of the quantization vectors is implemented with the aid of a parameter whose value depends on the size of the image to be coded.

Such a provision makes it possible to adapt to the size of the data at the disposal of the coder. Thus, if the image is small, the modifications of the dictionary must be of large amplitude, since few data are at the coder's disposal in order to capture the statistics of the video signal. On the other hand, if the image is large, it is possible to favor an updating of low amplitude, which is more resistant to irrelevant statistical variations of the video signal, since much more data are at the coder's disposal in order to adapt to these variations.

In yet another particular embodiment, if the current image is of Intra type, the quantization vectors are each initialized to predetermined values.

Such a provision makes it possible to keep the coding characteristic independent of the other images which is specific to the Intra images, even if the invention proposes an updating of the dictionary of quantization vectors which evolves in tandem with the processing of the images of a considered sequence of images. Indeed, it is generally desirable that the images of Intra type be coded and then decoded independently of any other image of the video stream, so as to be able to decode a video in the course of transmission (for example, to change channel on a television receiver, in the case of the broadcasting of an audiovisual stream). Thus, when an Intra image of this sequence must be coded, it cannot be coded with respect to a quantization vector of a dictionary which has been updated for an image previous to this Intra image. Consequently, the invention advantageously proposes initializing the quantization vectors of the dictionary to predetermined respective values so as to render the coding of the Intra Image independent of any other image of the sequence.

The various aforementioned embodiments or characteristics of realization can be added independently or in combination with one another, to the operations implemented in the course of the coding method such as defined hereinabove.

Correlatively, the invention relates to a device for coding at least one image split into blocks, comprising, for a current block to be coded of said image:
a prediction module for predicting the current block in accordance with a mode of prediction selected from among a plurality of predetermined modes of prediction, delivering a predictor block,
a calculation module for calculating a first set of data representative of a difference between the predictor block obtained and the current block,
a comparison module for comparing the first calculated set of data with a plurality of quantization vectors,
a selection module for selecting one of the quantization vectors according to a predetermined coding performance criterion,
a first coding module for coding an index associated with the selected quantization vector.

Such a coding device is noteworthy in that:
the calculation module is activated to calculate a second set of data representative of a difference between the first calculated set of data and the selected quantization vector, and in that it comprises a second coding module which is activated to code the second calculated set of data, at least one of the quantization vectors being modified as a function of the data of the second calculated set of data.

In a corresponding manner, the invention also relates to a method for decoding a data signal representative of at least one image split into blocks, implementing, for a current block to be decoded:
a decoding:
   of an index associated with a quantization vector which belongs to a set of quantization vectors,
   and of prediction data in respect of the current block to be decoded,
a decoding of the index,
a determination of the quantization vector associated with the decoded index,
an obtaining of a predictor block on the basis of the decoded prediction data.

Such a decoding method is noteworthy in that it comprises:
a determination, in the data signal, of data relating to the current block to be decoded,
a decoding of the data relating to the current block to be decoded, in the course of which at least one of the quantization vectors is modified as a function of the decoded data,
a reconstruction of the current block on the basis of the decoded data, of the quantization vector determined and of the predictor block obtained.

The data relating to the current block to be decoded are typically the values of the pixels of this block making it possible to reconstruct this block or values of transformed coefficients making it possible to reconstruct this block.

In a particular embodiment, the modification of one of the quantization vectors is implemented only if the decoded data fulfill a predetermined criterion. In another particular embodiment, the modification of one of the quantization vectors is implemented with the aid of a parameter whose value depends on the size of the image to be decoded.

In yet another particular embodiment, if the current image is of Intra type, the quantization vectors are each initialized to predetermined values.

The various aforementioned embodiments or characteristics of embodiment can be added independently or in combination with one another to the steps of the decoding method such as defined hereinabove.

Correlatively, the invention relates to a device for decoding a data signal representative of at least one image split into blocks, comprising, for a current block to be decoded:
a first decoding module for decoding:
   an index associated with a quantization vector which belongs to a set of quantization vectors,
   and prediction data in respect of the current block to be decoded,
a calculation module for determining the quantization vector associated with the decoded index,
a prediction module for obtaining a predictor block on the basis of the decoded prediction data.

Such a decoding device is noteworthy in that it comprises:
a second decoding module which is activated to decode data determined in the data signal and relating to the current block to be decoded, at least one of the quantization vectors being modified as a function of the decoded data,
a reconstruction module for reconstructing the current block on the basis of the decoded data, of the quantization vector determined and of the predictor block obtained.

The invention further relates to a computer program comprising instructions for implementing the coding method and/or the decoding method according to the invention, when it is executed on a computer.

Such a program can use any programming language, and be in the form of source code, object code, or of code intermediate between source code and object code, such as in a partially compiled form, or in any other desirable form.

Another subject of the invention also envisages a recording medium readable by a computer, and comprising computer program instructions, such as mentioned hereinabove.

The recording medium can be any entity or device capable of storing the program. For example, the medium can comprise a storage means, such as a ROM, for example a CD ROM or a microelectronic circuit ROM, or else a magnetic recording means, or else a digital recording means such as for example a USB key or a hard disk.

Moreover, such a recording medium can be a transmissible medium such as an electrical or optical signal, which can be conveyed via an electrical or optical cable, by radio or by other means. The program according to the invention can be in particular downloaded from a network of Internet type.

Alternatively, such a recording medium can be an integrated circuit in which the program is incorporated, the circuit being adapted to execute the coding and/or decoding method according to the invention or to be used in its and/or their execution.

### BRIEF DESCRIPTION OF THE DRAWINGS

Other characteristics and advantages will become apparent on reading a preferred embodiment described with reference to the figures in which:

FIG. 1 represents the steps of the coding method according to one embodiment of the invention,

FIG. 2 represents a coding device implementing the steps of the coding method of FIG. 1,

FIG. 3 represents a decoding device according to one embodiment of the invention,

FIG. 4 represents the steps of the decoding method which are implemented in the decoding device of FIG. 3.

### DETAILED DESCRIPTION OF THE CODING DART

An embodiment of the invention will now be described, in which the coding method according to the invention is used to code an image or a sequence of images according to a binary stream close to that which is obtained by a coding implemented in a coder in accordance with any one of the current or forthcoming video coding standards.

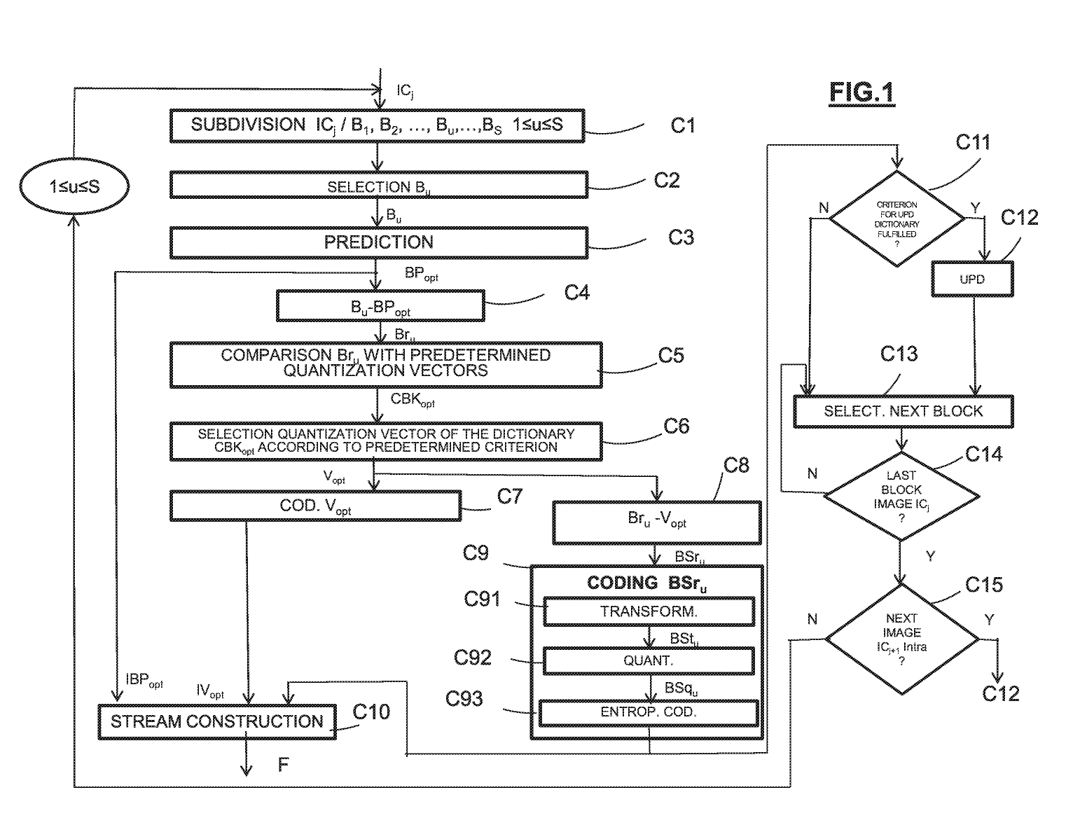

In this embodiment, the coding method according to the invention is for example implemented in a software or hardware manner by modifications of such a coder. The coding method according to the invention is represented in the form of an algorithm comprising steps C1 to C15 such as represented in FIG. 1.

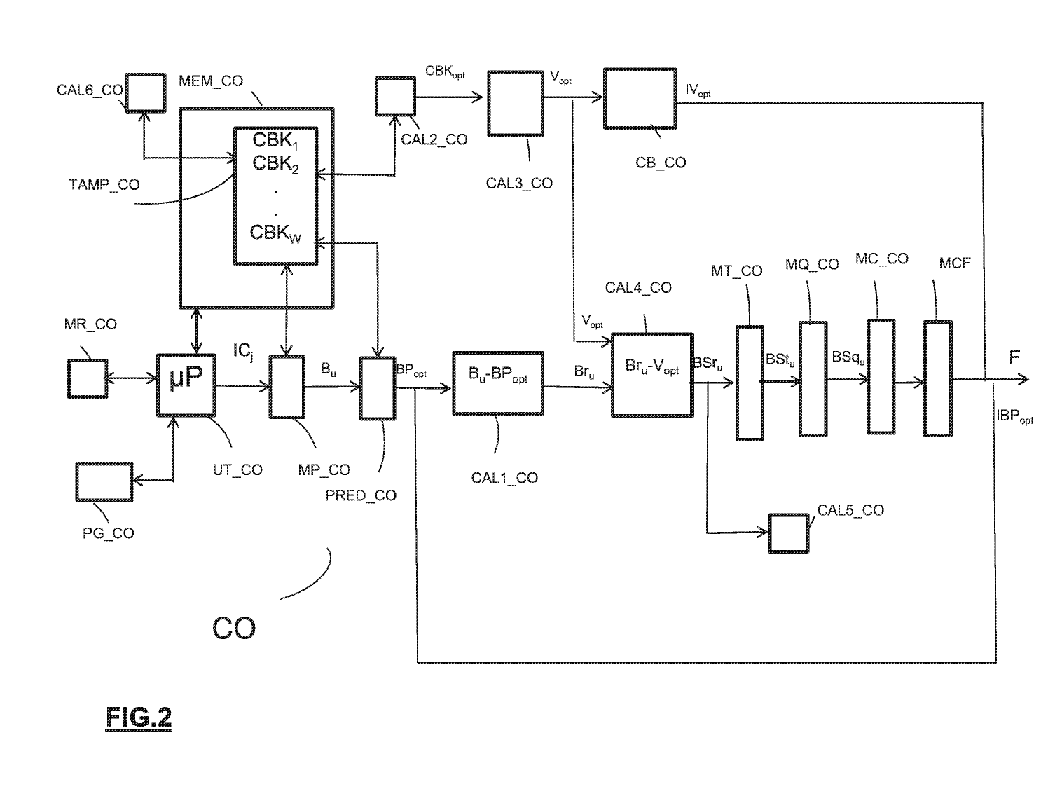

According to this embodiment, the coding method according to the invention is implemented in a coding device CO represented in FIG. 2.

As illustrated in FIG. 2, such a coding device comprises a memory MEM_CO comprising a buffer memory TAMP_CO, a processing unit UT_CO equipped for example with a microprocessor μP and driven by a computer program PG_CO which implements the coding method according to the invention. On initialization, the code instructions of the computer program PG_CO are for example loaded into a RAM memory MR_CO before being executed by the processor of the processing unit UT_CO.

The coding method represented in FIG. 1 applies to any current image ICⱼ which is fixed or else which forms part of a sequence of L images IC₁, . . . , ICⱼ, . . . , IC_{L} (1≦j≦L) to be coded.

In the course of a step C1 represented in FIG. 1, there is undertaken, in a manner known per se, the subdivision of a current image ICⱼ into a plurality of blocks B₁, B₂, . . . , Bᵤ, . . . , B_{S}(1≦u≦S). Such a subdivision step is implemented by a partitioning software module MP_CO represented in FIG. 2, which module is driven by the microprocessor μP of the processing unit UT_CO. It should be noted that within the meaning of the invention, the term “block” signifies coding unit. The latter terminology is in particular used in the HEVC standard “ISO/IEC/23008-2 Recommendation ITU-T H.265 High Efficiency Video Coding (HEVC)”.

In particular, such a coding unit groups together sets of pixels of rectangular or square shape, also called blocks or macroblocks, or else sets of pixels exhibiting other geometric shapes.

Said blocks B₁, B₂, . . . , Bᵤ, . . . , B_{S} are intended to be coded according to a predetermined scanning order, which is for example of the lexicographic type. This signifies that the blocks are coded one after another, from left to right.

Other types of traversal are of course possible. Thus, it is possible to subdivide the image ICⱼ into several sub-images called slices and to apply a subdivision of this type independently to each sub-image. It is also possible to code not a succession of rows, as explained hereinabove, but a succession of columns. It is also possible to traverse the rows or columns in either direction.

According to an example, the blocks B₁, B₂, . . . , Bᵤ, . . . , B_{S} have a square shape and all contain K pixels, with K21. According to a preferred embodiment, said blocks are 4×4 or 8×8 pixels in size.

As a function of the size of the image which is not necessarily a multiple of the size of the blocks, the last blocks on the left and the last blocks at the bottom might not be square. In an alternative embodiment, the blocks may be for example of rectangular size and/or not aligned with one another.

Each block may moreover be itself divided into sub-blocks which are themselves subdividable.

In the course of a step C2 represented in FIG. 1, the coder CO selects as current block a first block to be coded Bᵤ of the image ICⱼ, such as for example the first block B₁.

In the course of a step C3 represented in FIG. 1, there is undertaken the prediction of the current block Bᵤ by known techniques of Intra and/or Inter prediction. For this purpose, the block Bᵤ is predicted with respect to at least one predictor block in accordance with a mode of prediction selected from among a plurality of predetermined modes of prediction MP₀, MP₁, . . . , MPᵥ, . . . , MP_{Q} where 0≦v≦Q. In a manner known per se, the block Bᵤ is predicted with respect to a plurality of candidate predictor blocks. Each of the candidate predictor blocks is a block of pixels which has already been coded or else coded and then decoded. Such predictor blocks are stored beforehand in the buffer memory TAMP_CO of the coder CO, such as represented in FIG. 2.

According to an exemplary embodiment, the prediction is of Intra type which is, in a manner known per se, associated with a plurality of modes of prediction each defined by a predetermined direction. In the case of the Intra prediction for example proposed in the HEVC standard, there exist thirty-five possible directions of prediction, thus amounting to determining thirty-five candidate predictor blocks available for the prediction of the current block Bᵤ.

On completion of the prediction step C3, an optimal predictor block BPₒₚₜ is obtained subsequent to a setting into competition of said candidate predictor blocks, for example by minimizing a distortion bitrate criterion well known to the person skilled in the art. The block BPₒₚₜ is considered to be an approximation of the current block Bᵤ. The information relating to this prediction is intended to be written into a data signal or stream F to be transmitted to a decoder which will be described in greater detail in the subsequent description.

Step C3 is implemented by a predictive coding software module or processor PRED_CO represented in FIG. 2, which is driven by the microprocessor μP of the processing unit UT_CO.

In the course of a step C4 represented in FIG. 1, there is conventionally undertaken the comparison of the data relating to the current block Bᵤ with the data of the predictor block BPₒₚₜ. More precisely, in the course of this step, there is undertaken the calculation of the difference between the current block Bᵤ and the predictor block BPₒₚₜ obtained.

A first set of data, called a first residual block Brᵤ is then obtained on completion of step C4.

Step C4 is implemented by a calculation software module or processor CAL1_CO such as represented in FIG. 2, which is driven by the microprocessor μP of the processing unit UT_CO.

In the course of a step C5 represented in FIG. 1, there is undertaken a comparison of the first residual block Brᵤ with a plurality of quantization vectors. In a manner known per se, these quantization vectors belong to one or more dictionaries of quantization vectors available to the coder, denoted CBK₁, CBK₂, . . . , CBK_{W}. Such dictionaries are stored beforehand in the buffer memory TAMP_CO of the coder CO, such as represented in FIG. 2.

More precisely, step C5 consists in selecting one of said dictionaries of quantization vectors from among the available dictionaries CBK₁, CBK₂, . . . , CBK_{W}.

Step C5 is implemented by a calculation software module or processor CAL2_CO such as represented in FIG. 2, which is driven by the microprocessor μP of the processing unit UT_CO.

In accordance with the invention, such a selection is implemented as a function of one and/or of the other of the following elements:
the characteristics of the prediction (for example, the Intra mode chosen from among the 35 Intra modes of the HEVC standard) which was applied in step C3,
the frequency characteristics of the predictor block BPₒₚₜ,
the size of the current block Bᵤ,
characteristics of the current image ICⱼ, such as its size or its energy.

In the preferred embodiment, W=70, that is to say that:
in the case of a current block Bᵤ of size 4×4, there exists a different dictionary for each of the 35 Intra modes considered in the HEVC standard,
in the case of a current block Bᵤ of size 8×8, there exists a different dictionary for each of the 35 Intra modes considered in the HEVC standard.

In accordance with this preferred embodiment, the dictionary selected therefore depends both on the size of the current block Bᵤ and on the prediction mode selected.

The dictionary selected on completion of step C5 is denoted CBKₒₚₜ.

In the course of a step C6 represented in FIG. 1, there is undertaken a selection of one of the quantization vectors of the dictionary CBKₒₚₜ which was selected in step C5.

An optimal quantization vector Vₒₚₜ is obtained subsequent to a setting into competition of said quantization vectors of the dictionary CBKₒₚₜ, for example:
either by minimizing a distortion bitrate criterion well known to the person skilled in the art,
or by minimizing the mean square error calculated between the data of the residual block Brᵤ and the corresponding data of each of the quantization vectors of the dictionary CBKₒₚₜ.

The optimal quantization vector Vₒₚₜ is considered to be an approximation of the residual block Brᵤ. The information relating to this prediction is intended to be written into the aforementioned data signal F.

Step C6 is implemented by a calculation software module or processor CAL3_CO such as represented in FIG. 2, which is driven by the microprocessor μP of the processing unit UT_CO.

In the course of a step C7 represented in FIG. 1, there is undertaken a coding of the quantization vector Vₒₚₜ selected on completion of step C6.

Such a step consists in representing the index denoted IVₒₚₜ of the quantization vector Vₒₚₜ in binary form. For example, if the dictionary CBKₒₚₜ to which the quantization vector Vₒₚₜ belongs contains 256 quantization vectors, then the quantization vector Vₒₚₜ can be represented on 8 bits, thereby making it possible to precisely identify this vector from among all the other quantization vectors of the dictionary CBKₒₚₜ.

Step C7 is implemented by a binary coding software module or processor CB_CO such as represented in FIG. 2, which is driven by the microprocessor μP of the processing unit UT_CO.

In the course of a step C8 represented in FIG. 1, there is undertaken the comparison of the data relating to the residual block Brᵤ with the data of the vector Vₒₚₜ. More precisely, in the course of this step, there is undertaken the calculation of the difference between the residual block Brᵤ and the vector Vₒₚₜ.

A second set of data, called a secondary residual block BSrᵤ, is then obtained on completion of step C8.

Step C8 is implemented by the software module or processor CAL4_CO represented in FIG. 2.

In the course of a step C9 represented in FIG. 1, there is undertaken, in accordance with the invention, a coding of the data of the secondary residual block BSrᵤ.

In the course of step C9, there is undertaken, in the course of a sub-step C91, a transformation of the secondary residual block BSrᵤ according to a conventional direct transformation operation, to produce a transformed block BStᵤ.

Sub-step C91 is implemented by a transformation software module or processor MT_CO represented in FIG. 2, which is driven by the microprocessor μP of the processing unit UT_CO.

The processor MT_CO is able to implement a direct transformation such as for example a discrete cosine transformation (DCT), a discrete sine transformation (DST), a discrete wavelet transformation (DWT).

In the course of step C9, there is furthermore undertaken, in the course of a sub-step C92 represented in FIG. 1, a quantization of the data of the transformed block BStᵤ, to produce a quantized block BSqᵤ made up of quantized coefficients. Such a quantization step is for example of scalar or vector type.

Sub-step C92 is performed by means of a quantization software module or processor MQ_CO such as represented in FIG. 2, which module is driven by the microprocessor μP of the processing unit UT_CO.

In a manner known per se, in the course of step C9, there is furthermore undertaken, in the course of a sub-step C93 represented in FIG. 1, the coding of the quantized coefficients of the block BSqᵤ. Such a coding is for example an entropy coding of CABAC type (“Context Adaptive Binary Arithmetic Coding” in English) or else an entropy coding of arithmetic or Huffman type.

Sub-step C93 is implemented by a coding software module or processor MC_CO represented in FIG. 2, which module is driven by the microprocessor μP of the processing unit UT_CO.

In the course of a step C10 represented in FIG. 1, there is undertaken the construction of the data signal or stream F which contains:
the data coded on completion of the aforementioned step C9,
the index IVₒₚₜ of the optimal quantization vector Vₒₚₜ.

Step C10 is implemented by a data signal construction software module or processor MCF, such as represented in FIG. 2.

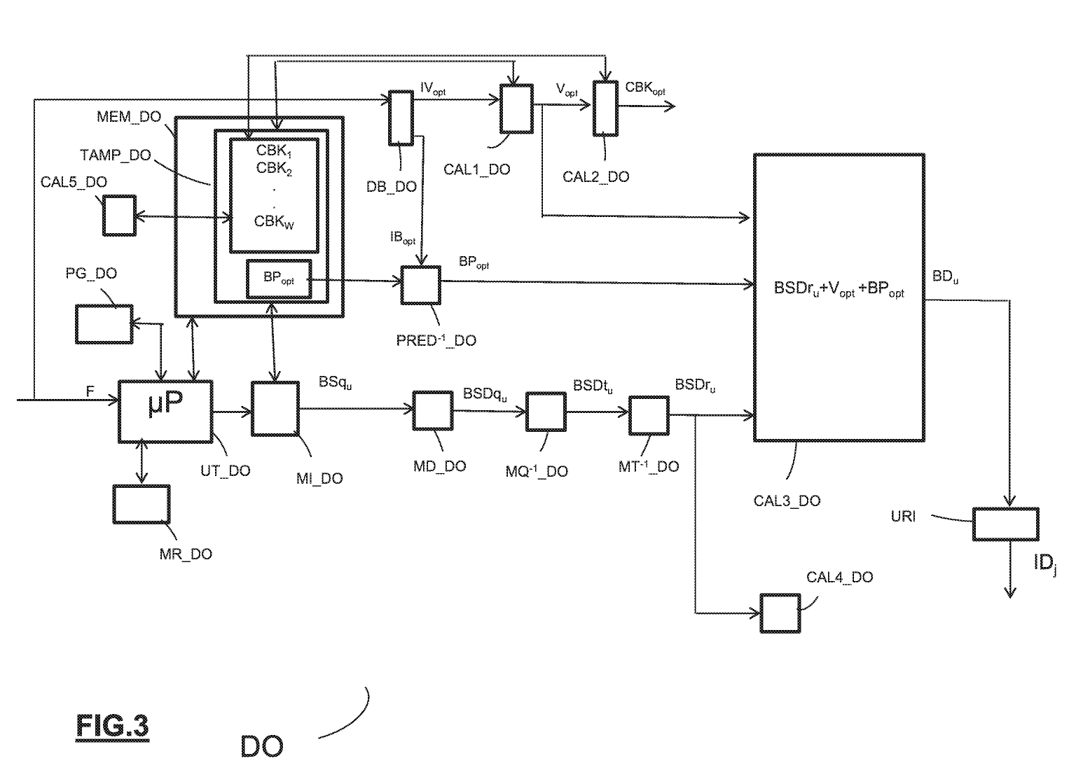

The data signal F is thereafter transmitted by a communication network (not represented) to a remote terminal. The latter comprises the decoder DO represented in FIG. 3.

In a manner known per se, the data signal F furthermore comprises certain information encoded by the coder CO, such as the type of prediction (Inter or Intra) applied in step C3, and if appropriate, the mode of prediction selected, the index of the predictor block obtained BPₒₚₜ obtained on completion of step C3, denoted IBPₒₚₜ the type of partitioning of the current block Bᵤ if the latter has been partitioned, the reference image index and the displacement vector that were used in the Inter mode of prediction.

In a manner known per se, there is thereafter undertaken the decoding of the residual block BSrᵤ. A decoded residual block BSDrᵤ is then obtained. There is then undertaken the construction of the decoded block BDᵤ by adding to the predicted block BPₒₚₜ the decoded residual block BSDrᵤ.

It should be noted that the decoded block BDᵤ is the same as the decoded block obtained on completion of the method for decoding the image ICⱼ which will be described further on in the description. The decoded block BDᵤ is thus made available to be used by the coder CO of FIG. 2.

In the course of a step C11 represented in FIG. 1, in accordance with the invention, there is undertaken a test which consists in verifying whether a criterion for updating the dictionaries CBK₁, CBK₂, . . . , CBK_{W} is or is not fulfilled.

According to a first variant, such a criterion consists in comparing the number of non-zero coefficients in the residual block BSrᵤ with a predetermined threshold. For example, the updating criterion is considered to be fulfilled if the number of non-zero coefficients is greater than 3.

According to a second variant, such a criterion consists in comparing the bitrate of the coding of the residual block BSrᵤ with a predetermined threshold. For example, the updating criterion is considered to be fulfilled if the bitrate of the coding of the residual block BSrᵤ is greater than 10 bits.

Step C11 is implemented by a calculation software module or processor CAL5_CO such as represented in FIG. 2, which is driven by the microprocessor μP of the processing unit UT_CO.

If the updating criterion is fulfilled, in the course of a step C12 represented in FIG. 1, there is undertaken an updating of at least one of the dictionaries CBK₁, CBK₂, . . . , CBK_{W}.

Step C12 is implemented by a calculation software module or processor CAL6_CO such as represented in FIG. 2, which is driven by the microprocessor μP of the processing unit UT_CO.

According to a first variant, step C12 consists in re-updating the set of current dictionaries CBK₁, CBK₂, . . . , CBK_{W}.

According to a second preferred variant, only an updating of the dictionary CBKₒₚₜ is undertaken.

In the preferred embodiment, the dictionary CBKₒₚₜ is updated in the following manner.

The vector Vₒₚₜ, as well as its neighbors contained in the dictionary CBKₒₚₜ, are firstly considered. The neighbors are denoted V_{opt-R}, V_{opt-R+1}, V_{opt-R+2}, . . . , Vₒₚₜ₋₁, Vₒₚₜ, Vₒₚₜ₊₁, . . . , V_{opt+R-2}, V_{opt+R-1}, V_{opt+R}.

The parameter R which defines the number of following and preceding neighbors of the vector Vₒₚₜ is predetermined, for example at the value 5. According to this configuration, the 5 neighbor vectors which succeed and precede the vector Vₒₚₜ are considered.

Next, vectors Zₒₚₜ₊ₙ, n belonging to <−R,+R>, are constructed with a view to the updating, in the following manner:

Zₒₚₜ₊ₙ=Vₒₚₜ₊ₙ+alpha*f(n)*((Vₒₚₜ+BSrᵤ)−Vₒₚₜ₊ₙ)

where:
alpha is a predetermined parameter, for example equal to 0.1,
and f(n) is a value which depends on the distance between the index n and the index opt.

For example, in the preferred embodiment:

f(n)=0.2*(5−n)/5

The vectors Zₒₚₜ₊ₙ with n ranging from −5 to +5 are therefore calculated, and respectively replace the vectors Vₒₚₜ₊ₙ in the dictionary CBKₒₚₜ.

The set of current dictionaries CBK₁, CBK₂, . . . , CBK_{W} is therefore thus re-updated.

In an alternative embodiment, the parameters of the updating can be different according to the size of the image. Indeed, if the image is small, a fast learning of the statistics of the current image ICⱼ is necessary.

For example:
for an image size belonging to a single-definition SD video (the English abbreviation standing for “Standard Definition”), i.e. fewer than 720 pixels high and fewer than 1280 pixels wide, a parameter alpha equal to 0.3 is adopted;
for an image size belonging to a High-Definition HD video, i.e. between 720 and 1080 pixels high and between 1280 and 1920 pixels wide, or much greater than 1280×1920 pixels, a parameter alpha equal to 0.2 is adopted;
for an image size greater than the size of an HD image, a parameter equal to 0.1 is adopted.

It is of course possible to re-update the dictionaries in other ways. For example, it is possible to apply the same type of quantization vector updating as in the preferred mode. However, the updating, instead of being applied to the neighbor vectors of the quantization vector Vₒₚₜ in the dictionary CBKₒₚₜ, is applied to the vectors close to Vₒₚₜ+BSDrᵤ in the sense of the distortion. As a variant, the updating is applied to vectors close to Vₒₚₜ+BSDrᵤ not only in the dictionary CBKₒₚₜ, but in the set of current dictionaries CBK₁, CBK₂, . . . , CBK_{W}.

Subsequent to the aforementioned step C12, there is undertaken, in the course of a step C13 represented in FIG. 1, the selection of the following block of the current image ICⱼ. Next, the block coding steps described hereinabove are again implemented for this following block.

If on completion of the aforementioned step C11, the updating criterion is not fulfilled, there is undertaken, in the course of the aforementioned step C13, the selection of the following block of the current image ICⱼ. Next, the block coding steps described hereinabove are again implemented for this following block.

In the course of a step C14 represented in FIG. 1, the coder CO of FIG. 2 tests whether the current block which has been coded in accordance with the coding method described hereinabove is the last block of the current image ICⱼ.

If such is not the case, the aforementioned step C12 is implemented.

If the current block is the last block of the current image ICⱼ, in the course of a step C15 represented in FIG. 1, the coder CO of FIG. 2 tests whether or not the following current image ICⱼ₊₁ is an image of Intra type.

In the case where the following current image ICⱼ₊₁ is of Intra type, before undertaking the coding of the blocks of this image in accordance with the coding method of FIG. 1, step C12 of updating the dictionaries is implemented.

In the example represented, the quantization vectors of the dictionary CBKₒₚₜ are then each initialized to a predetermined respective value.

In the case where the following current image ICⱼ₊₁ is not of Intra type, there is directly undertaken the coding of the blocks of this image in accordance with the coding method of FIG. 1.

The coding steps C1 to C15 which have just been described hereinabove are thereafter implemented for each of the blocks B₁, B₂, . . . , Bᵤ, . . . , B_{S} to be coded of the current image ICⱼ considered, in a predetermined order which is for example the lexicographic order.

### Detailed Description of the Decoding Part

An embodiment of the invention will now be described, in which the decoding method according to the invention is used to decode a data signal or stream representative of an image or of a sequence of images which is able to be decoded by a decoder in accordance with any one of the current or forthcoming video decoding standards.

In this embodiment, the decoding method according to the invention is for example implemented in a software or hardware manner by modifications of such a decoder.

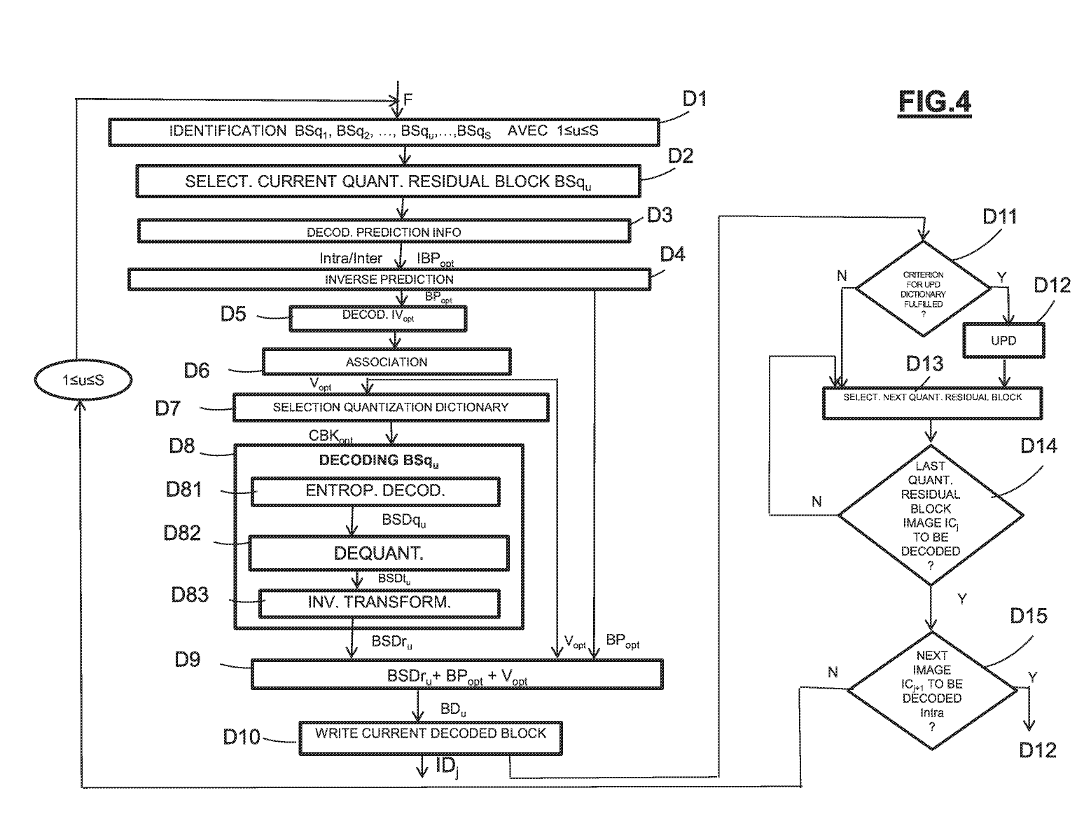

The decoding method according to the invention is represented in the form of an algorithm comprising steps D1 to D15 such as represented in FIG. 4.

According to this embodiment, the decoding method according to the invention is implemented in a decoding device or decoder DO represented in FIG. 3.

As illustrated in FIG. 3, according to this embodiment of the invention, the decoder DO comprises a memory MEM_DO which itself comprises a buffer memory TAMP_DO, a processing unit UT_DO equipped for example with a microprocessor μP and driven by a computer program PG_DO which implements the decoding method according to the invention. On initialization, the code instructions of the computer program PG_DO are for example loaded into a RAM memory, denoted MR_DO, before being executed by the processor of the processing unit UT_DO.

The decoding method represented in FIG. 4 is applied to a data signal or stream F representative of a current image ICⱼ to be decoded which is fixed or which belongs to a sequence of images to be decoded.

For this purpose, information representative of the current image ICⱼ to be decoded is identified in the data signal F received at the decoder DO and such as delivered on completion of the coding method of FIG. 1.

With reference to FIG. 4, in the course of a step D1, there is undertaken the identification in the signal F of the quantized residual blocks BSq₁, BSq₂, . . . , BSqᵤ, . . . , BSq_{S} (1≦u≦S) associated respectively with the blocks B₁, B₂, . . . , Bᵤ, . . . , B_{S} coded previously in accordance with the aforementioned lexicographic order, in the course of the coding step C9 of FIG. 1.

Such an identification step is implemented by a stream analysis identification software module or processor MI_DO, such as represented in FIG. 3, said module being driven by the microprocessor μP of the processing unit UT_DO.

Other types of traversal than that which has just been described hereinabove are of course possible and depend on the order of traversal chosen on coding.

In the example represented, the blocks B₁, B₂, . . . , Bᵤ, . . . , B_{S} to be decoded have a square shape and all contain K pixels, with K21. According to a preferred embodiment, said blocks to be decoded are 4×4 or 8×8 pixels in size.

As a function of the size of the image which is not necessarily a multiple of the size of the blocks, the first blocks at the top, on the left of the image, and the last blocks at the bottom, on the right of the image, might not be square. In an alternative embodiment, the blocks may be for example of rectangular size and/or not aligned with one another.

Each block to be decoded can moreover be itself divided into sub-blocks which are themselves subdividable.

In the course of a step D2 represented in FIG. 4, the decoder DO of FIG. 3 selects as current block the first quantized block BSqᵤ which contains quantized data which were coded in the course of sub-step C93 of FIG. 1.

In the course of a step D3 represented in FIG. 4, there is undertaken a decoding of the information relating to the prediction of the current block Bᵤ such as implemented on coding, in the course of step C3 of FIG. 1, and which were written into the data signal F. Such reconstruction information comprises the type of prediction (Inter or Intra) applied in step C3, and if appropriate, the mode of prediction selected, the index IBₒₚₜ of the predictor block obtained BPₒₚₜ obtained on completion of step C3, the type of partitioning of the current block Bᵤ if the latter has been partitioned, the reference image index and the displacement vector that were used in the Inter mode of prediction.

Such a decoding step D3 is implemented by the binary decoding module DB_DO represented in FIG. 3.

In the course of a step D4 represented in FIG. 4, there is undertaken the predictive decoding of the current block to be decoded with the aid of the index IBₒₚₜ of the predictor block BPₒₚₜ which was decoded in the course of the aforementioned step D3. For this purpose, in a manner known per se, there is undertaken, in association with the decoded index of the predictor block BPₒₚₜ, the selection, in the buffer memory TAMP_DO of the decoder DO of FIG. 3, of the corresponding predictor block BPₒₚₜ, which figures among a plurality of candidate predictor blocks stored beforehand in the buffer memory TAMP_DO. Each of the candidate predictor blocks is a block of pixels which has already been decoded.

Step D4 is implemented by an inverse prediction software module or processor PRED⁻¹_DO such as represented in FIG. 3, which is driven by the microprocessor μP of the processing unit UT_DO.

In the course of a step D5 represented in FIG. 4, there is undertaken a decoding of the index IVₒₚₜ of the optimal quantization vector Vₒₚₜ which was selected on completion of step C6 of FIG. 1.

Such a decoding step D5 is implemented by the decoding module DB_DO of FIG. 3.

In the course of a step D6 represented in FIG. 4, there is undertaken the determination of the optimal quantization vector Vₒₚₜ associated with the decoded index IVₒₚₜ.

Step D6 is implemented by a calculation software module or processor CAL1_DO such as represented in FIG. 3, which is driven by the microprocessor μP of the processing unit UT_DO.

In the course of a step D7 represented in FIG. 4, there is undertaken the selection of a dictionary of quantization vectors, denoted CBKₒₚₜ, which contains the quantization vector Vₒₚₜ selected in step D6. Such a dictionary belongs to a plurality of available dictionaries of quantization vectors, denoted CBK₁, CBK₂, . . . , CBK_{W}. Such dictionaries are stored beforehand in the buffer memory TAMP_DO of the decoder DO, such as represented in FIG. 3.

Step D7 is implemented by a calculation software module or processor CAL2_DO such as represented in FIG. 3, which is driven by the microprocessor μP of the processing unit UT_DO.

In accordance with the invention, in a manner corresponding to the coding, such a selection is implemented as a function of one and/or of the other of the following elements:
the characteristics of the prediction (for example, the Intra mode chosen from among the 35 Intra modes of the HEVC standard), whose indices have been decoded in step D3,
the frequency characteristics of the predictor block BPₒₚₜ whose index IBₒₚₜ has been decoded in step D3,
the size of the current block Bᵤ to be decoded,
characteristics of the current image ICⱼ to be decoded, such as its size or its energy.

In the preferred embodiment, W=70, that is to say that:
in the case of a current block Bᵤ of size 4×4, there exists a different dictionary for each of the 35 Intra modes considered in the HEVC standard,
in the case of a current block Bᵤ of size 8×8, there exists a different dictionary for each of the 35 Intra modes considered in the HEVC standard.

In accordance with this preferred embodiment, the dictionary selected therefore depends both on the size of the current block Bᵤ to be decoded and on the mode of prediction whose index has been decoded in step D3.

In the course of a step D8 represented in FIG. 4, there is undertaken, in accordance with the invention, a decoding of the data of the quantized residual block BSqᵤ.

In the course of step D8, there is undertaken, in the course of a sub-step D81 represented in FIG. 4, a decoding of the current set of quantized coefficients BSqᵤ.

Such a decoding is for example an entropy decoding of CABAC type or else an entropy decoding of arithmetic or Huffman type.

On completion of the aforementioned sub-step D81, a set BSDqᵤ of digital information associated with the current set of quantized coefficients BSqᵤ is obtained.

Such a decoding sub-step D81 is implemented by an entropy decoding module MD_DO represented in FIG. 3, which is driven by the microprocessor μP of the processing unit UT_DO.

In the course of step D8, there is undertaken, in the course of a sub-step D82 represented in FIG. 4, a dequantization of the digital information obtained subsequent to sub-step D81, according to a conventional dequantization operation which is the operation inverse to the quantization implemented during the quantization sub-step C92 of FIG. 1. A current set of dequantized coefficients BSDtᵤ is then obtained on completion of sub-step D82. Such a dequantization sub-step is for example of scalar or vector type.

Sub-step D82 is performed by means of a quantization software module or processor MQ⁻¹_DO represented in FIG. 3, which is driven by the microprocessor μP of the processing unit UT_DO.

In the course of step D8, there is undertaken, in the course of a sub-step D83 represented in FIG. 4, a transformation of the current set of dequantized coefficients BSDtᵤ, such a transformation being an inverse direct transformation. This transformation is the operation inverse to the transformation performed in sub-step C91 of FIG. 1. On completion of sub-step D83, a current decoded residual block BSDrᵤ is obtained.

Sub-step D83 is implemented by an inverse transformation software module or processor MT⁻¹_DO, such as represented in FIG. 3, which is driven by the microprocessor μP of the processing unit UT_DO.

The processor MT⁻¹_DO is able to implement an inverse direct transformation such as for example an inverse discrete cosine transformation of DCT⁻¹ type, an inverse discrete sine transformation of DST⁻¹ type, an inverse discrete wavelet transformation of DWT⁻¹ type.

In the course of a step D9 represented in FIG. 4, there is undertaken, in accordance with the invention, the reconstruction of the current block Bᵤ by adding to the decoded residual block BSDrᵤ, obtained on completion of sub-step D83:
the optimal predictor block BPₒₚₜ which was obtained on completion of the aforementioned step D4,
and the optimal quantization vector Vₒₚₜ which was obtained on completion of the aforementioned step D6.

On completion of step D9, a current decoded block BDᵤ is obtained.

Step D9 is implemented by a calculation software module or processor CAL3_DO represented in FIG. 3, which is driven by the microprocessor μP of the processing unit UT_DO.

In the course of a step D10 represented in FIG. 4, said decoded block BDᵤ is written in a decoded image IDⱼ.

Such a step is implemented by an image reconstruction software module or processor URI such as represented in FIG. 3, said module being driven by the microprocessor μP of the processing module UT_DO.

In the course of a step D11 represented in FIG. 4, there is undertaken a test which consists in verifying whether a criterion for updating the dictionaries CBK₁, CBK₂, . . . , CBK_{W} is or is not fulfilled.

According to a first variant, such a criterion consists in comparing the number of non-zero coefficients in the decoded residual block BSDrᵤ with a predetermined threshold. For example, the updating criterion is considered to be fulfilled if the number of non-zero coefficients is greater than 3.

According to a second variant, such a criterion consists in comparing the bitrate of the coding of the decoded residual block BSDrᵤ with a predetermined threshold. For example, the updating criterion is considered to be fulfilled if the bitrate of the coding of the decoded residual block BSDrᵤ is greater than 10 bits.

Step D11 is implemented by a calculation software module or processor CAL4_DO such as represented in FIG. 3, which is driven by the microprocessor μP of the processing unit UT_DO.

If the updating criterion is fulfilled, in the course of a step D12 represented in FIG. 4, there is undertaken an updating of at least one of the dictionaries CBK₁, CBK₂, . . . , CBK_{W}.

Step D12 is implemented by a calculation software module or processor CAL5_DO such as represented in FIG. 3, which is driven by the microprocessor μP of the processing unit UT_DO.

Step D12 being identical to step C12 of updating the dictionaries such as implemented on coding with reference to FIG. 1, this step will not be described at greater length.

Subsequent to the aforementioned step D12, there is undertaken, in the course of a step D13 represented in FIG. 4, the selection of the following quantized residual block of the current image ICⱼ to be decoded. Next the steps described hereinabove of decoding the following quantized residual block are again implemented.

If on completion of the aforementioned step D11, the updating criterion is not fulfilled, there is undertaken, in the course of the aforementioned step D13, the selection of the following quantized residual block of the current image ICⱼ to be decoded. Next the steps described hereinabove of decoding the following quantized residual block are again implemented.

In the course of a step D14 represented in FIG. 4, the decoder DO of FIG. 3 tests whether the current block which has been decoded in accordance with the decoding method described hereinabove is the last block of the current image ICⱼ to be decoded.

If such is not the case, the aforementioned step D13 is implemented.

If the current block is the last block of the current image ICⱼ to be decoded, in the course of a step D15 represented in FIG. 4, the decoder DO of FIG. 3 tests whether or not the following current image ICⱼ₊₁ to be decoded is an image of Intra type.

In the case where the following current image ICⱼ₊₁ to be decoded is of Intra type, before undertaking the decoding of the blocks of this image in accordance with the decoding method of FIG. 4, step D12 of updating the dictionaries is implemented.

In the example represented, the quantization vectors of the dictionary CBKₒₚₜ are each initialized to a predetermined respective value.

In the case where the following current image ICⱼ₊₁ to be decoded is not of Intra type, there is directly undertaken the decoding of the blocks of this image in accordance with the decoding method of FIG. 4.

The decoding steps which have just been described hereinabove are implemented for all the blocks B₁, B₂, . . . , Bᵤ, . . . , B_{S} to be decoded of the current image ICⱼ considered, in a predetermined order which is for example the lexicographic order.

It goes without saying that the embodiments which have been described hereinabove have been given purely by way of wholly non-limiting indication, and that numerous modifications can be easily made by the person skilled in the art without however departing from the scope of the invention.

1. A method for coding at least one image split into blocks, comprising the following acts implemented by a coding device:
for a current block (Bᵤ) to be coded of said image:
predicting the current block in accordance with a mode of prediction selected from among a plurality of predetermined modes of prediction,
obtaining a predictor block on completion of said prediction,
calculating a first set of data representative of a difference between the predictor block obtained and the current block,
comparing said first calculated set of data with a plurality of quantization vectors,
selecting one of the quantization vectors according to a predetermined coding performance criterion,
coding an index associated with said selected quantization vector,
calculating a second set of data representative of a difference between the first calculated set of data and the selected quantization vector, and
coding the second calculated set of data in the course of which at least one of said quantization vectors is modified as a function of the data of the second calculated set of data.

2. The coding method as claimed in claim 1, in which the modification of one of said quantization vectors is implemented only if the data of the second calculated set of data fulfill a predetermined criterion.

3. The coding method as claimed in claim 1, in which the modification of one of said quantization vectors is implemented with the aid of a parameter whose value depends on the size of the image to be coded.

4. The coding method as claimed in claim 1, in which if said current image is of Intra type, the quantization vectors are each initialized to predetermined values.

5. A coding device for coding at least one image split into blocks, comprising:
a processor, and
a non-transitory computer-readable medium comprising instructions stored thereon, which when executed by the processor configure the coding device to perform acts comprising:
for a current block (Bᵤ) to be coded of said image:
predicting the current block in accordance with a mode of prediction selected from among a plurality of predetermined modes of prediction delivering a predictor block (BPₒₚₜ),
calculating a first set of data representative of a difference between the predictor block obtained and the current block,
comparing said first calculated set of data with a plurality of quantization vectors,
selecting one of the quantization vectors according to a predetermined coding performance criterion,
coding an index associated with said selected quantization vector,
calculating a second set of data representative of a difference between the first calculated set of data and the selected quantization vector, and
coding the second calculated set of data, at least one of said quantization vectors being modified as a function of the data of the second calculated set of data.

6. (canceled)

7. A non-transitory computer-readable recording medium on which is recorded a computer program comprising program code instructions for execution a coding method for coding at least one image split into blocks, when said program is executed by a computer, wherein the method comprises:
for a current block (Bᵤ) to be coded of said image:
predicting the current block in accordance with a mode of prediction selected from among a plurality of predetermined modes of prediction,
obtaining a predictor block on completion of said prediction,
calculating a first set of data representative of a difference between the predictor block obtained and the current block,
comparing said first calculated set of data with a plurality of quantization vectors,
selecting one of the quantization vectors according to a predetermined coding performance criterion,
coding an index associated with said selected quantization vector,
calculating a second set of data representative of a difference between the first calculated set of data and the selected quantization vector, and
coding the second calculated set of data in the course of which at least one of said quantization vectors is modified as a function of the data of the second calculated set of data.

8. A method for decoding a data signal representative of at least one image split into blocks, comprising the following acts performed by a decoding device:
for a current block to be decoded:
decoding:
an index associated with a quantization vector which belongs to a set of quantization vectors,
and prediction data in respect of the current block to be decoded,
determining said quantization vector associated with said decoded index,
obtaining a predictor block on the basis of the decoded prediction data,
determining, in said data signal, data relating to the current block to be decoded,
decoding the data relating to the current block to be decoded, in the course of which at least one of said quantization vectors is modified (D12) as a function of the decoded data, and
reconstructing the current block on the basis of the decoded data, of said quantization vector and of the predictor block obtained.

9. The decoding method as claimed in claim 8, in which the modification of one of said quantization vectors is implemented only if the decoded data fulfill a predetermined criterion.

10. The decoding method as claimed in claim 8, in which the modification of one of said quantization vectors is implemented with the aid of a parameter whose value depends on the size of the image to be decoded.

11. The decoding method as claimed in claim 8, in which if said current image is of Intra type, the quantization vectors are each initialized to predetermined values.

12. A decoding device for decoding a data signal representative of at least one image split into blocks, comprising:
a processor, and
a non-transitory computer-readable medium comprising instructions stored thereon, which when executed by the processor configure the decoding device to perform acts comprising:
for a current block (Bᵤ) to be decoded:
decoding:
an index associated with a quantization vector which belongs to a set of quantization vectors,
and prediction data in respect of the current block to be decoded,
determining said quantization vector associated with said decoded index,
obtaining a predictor block on the basis of the decoded prediction data,
decoding data determined in the data signal and relating to the current block to be decoded, at least one of said quantization vectors being modified as a function of the decoded data,
reconstructing the current block on the basis of the decoded data, of said quantization vector determined and of the predictor block obtained.

13. (canceled)

14. A non-transitory computer-readable recording medium on which is recorded a computer program comprising program code instructions for execution of a decoding method for decoding a data signal representative of at least one image split into blocks, when said program is executed by a computer, wherein the method comprises:
for a current block to be decoded:
decoding:
an index associated with a quantization vector which belongs to a set of quantization vectors,
and prediction data in respect of the current block to be decoded,
determining said quantization vector associated with said decoded index,
obtaining a predictor block on the basis of the decoded prediction data,
determining, in said data signal, data relating to the current block to be decoded,
decoding the data relating to the current block to be decoded, in the course of which at least one of said quantization vectors is modified (D12) as a function of the decoded data, and
reconstructing the current block on the basis of the decoded data, of said quantization vector and of the predictor block obtained.

15. The coding method of claim 1, further comprising:
forming a data signal comprising the coded second set of data and the coded index associated with said selected quantization vector, and
transmitting the data signal on a communication network.

16. The decoding method of claim 8, further comprising:
receiving the data signal from a communication network.
